(19) United States
(12) Patent Application Publication
(10) Pub. No.: US 2016/0186786 A1
(43) Pub. Date: Jun. 30, 2016

(54) Controller Apparatus for an Electro-Hydraulic Drive Unit

(71) Applicant: Robert Bosch GmbH, Stuttgart (DE)

(72) Inventor: Matthias Wahler, Muedesheim (DE)

(21) Appl. No.: 14/974,161

(22) Filed: Dec. 18, 2015

(30) Foreign Application Priority Data
Dec. 19, 2014 (DE) 10 2014 226 617.3

(51) Int. Cl. F15B 11/08

(52) U.S. Cl. CPC F15B 11/08; F15B 2211/40576; F15B 2211/6651; F15B 2211/40

(57) ABSTRACT

A drive control device for operating an electro-hydraulic drive which has an electric motor with a variable rotational speed, a hydraulic pump which is driven by the electric motor, a hydraulic consumer with a movable element and hydromechanical safety device which is configured to be able to interrupt a flow of hydraulic fluid between the hydraulic pump and the hydraulic consumer, comprises a controller configured to actuate the electric motor for operation, and to interrupt the operation of the electric motor. The drive control device is configured to actuate the hydromechanical safety device in such a way that the flow of hydraulic fluid between the hydraulic pump and the hydraulic consumer is interrupted.

The present invention relates to a drive control device for operating an electro-hydraulic drive, to such an electro-hydraulic drive and to a method for stopping a movable element of such an electro-hydraulic drive.

### PRIOR ART

An electro-hydraulic axle comprises a hydraulic drive with a motor, a hydraulic pump and a hydraulic cylinder, in which electrical or electronic control of, for example, the position of the cylinder or the piston thereof as a positionable element is possible. Such electro-hydraulic axles are used, for example, for what are referred to as deep-drawer presses, injection molding machines or else also in other shaping technology machines. Likewise there are electromechanical axles in which the axle is driven directly by means of the motor.

In machines in which an axle (the positionable element thereof is meant below) can be set in motion, safety measures should generally be provided which can stop the axle when necessary and hold it in its actual position. Such cases of need may be, for example, that an operator comes too close to the moving axle, that the hazardous area has to be entered by operating personnel operating at manual workstations, etc.

Such stations are conventionally provided with a separating protective device, in particular a protective door, a protective grille, etc., which is kept closed with a safety device as long as the axle is moving. If the hazardous area is entered, the axle is to be stopped by means of a safety function such as, for example, with the STO (Save Torque Off) safety function.

For this purpose, there are also drive controllers for such moving axles with a safety device by means of which the electric motor can be switched off. Examples of this can be found in DE 10 2012 012 047 A1, DE 10 2012 012 048 A1, DE 43 30 824 A1 or DE 10 2007 017 285 A1.

In electro-hydraulic axles, hydromechanical safety means for interrupting a flow of hydraulic fluid into or out of the hydraulic consumer can also be provided. It is therefore possible, for example, to implement a lifting system, in particular for safe lifting. Such hydromechanical safety means have, however, hitherto been actuated in a purely hydraulic fashion. Therefore, additional actuation components and high costs are involved. In addition, the safety devices for electric motors and hydromechanical safety means operate separately from one another and adjustment is therefore not readily possible.

It is therefore desirable to specify a simple, efficient and cost-effective possible way of actuating an electro-hydraulic drive with an electric motor and additional hydromechanical safety means.

### DISCLOSURE OF THE INVENTION

According to the invention, a drive control device, an electro-hydraulic drive and a method for stopping a movable element of an electro-hydraulic drive having the features of the independent patent claims are proposed. Advantageous refinements are the subject matter of the dependent claims and of the following description.

### ADVANTAGES OF THE INVENTION

A drive control device according to the invention is suitable for operating an electro-hydraulic drive which has an electric motor with a variable rotational speed, a hydraulic pump which is driven by the electric motor, a hydraulic consumer with a movable element, and hydromechanical safety means which are configured to be able to interrupt a flow of hydraulic fluid between the hydraulic pump and the hydraulic consumer. In this context, the drive control device is configured to actuate the electric motor for operation, and to interrupt the operation of the electric motor, and is also configured to actuate the hydromechanical safety means in such a way that the flow of hydraulic fluid between the hydraulic pump and the hydraulic consumer is interrupted.

In order to actuate the electric motor it is possible to provide, for example, an open-loop control in the drive control device and an, if appropriate, external power component. The power component can then be disabled, for example, in order to interrupt the operation of the electric motor. With a drive control device according to the invention it is then additionally also possible to actuate hydromechanical safety means which have hitherto been controlled by means of purely hydraulic actuation systems, in order, for example, to interrupt the flow of hydraulic fluid in a safety-relevant case, and thereby to bring the movable element of the hydraulic consumer to a standstill. It is therefore possible to avoid an additional actuation device, which permits installation space and costs to be saved. The hydraulic safety means can be, for example, electromagnetically actuated valves which can be closed by the drive control device, if appropriate by means of corresponding electronic modules.

Furthermore, conventional drive control devices, which can usually only interrupt the operation of the electric motor or, if appropriate, actuate other purely electromechanical components such as a brake, usually already perform the relevant safety tasks with the result that, for example, electronic modules which are used for this purpose can additionally be provided in the drive control device, if appropriate after they have been correspondingly adapted to the actuation of the hydromechanical safety means. In addition, simple coordination of the actuation of the electric motor and safety means is possible, which is not possible, or possible only with additional expenditure, in the case of separate drive control systems. The costs and complexity when putting the devices into service and certifying them can therefore be considerably reduced.

The drive control device is also preferably configured to actuate the electric motor and/or the hydromechanical means on two channels. Two channel actuation is to be understood as meaning that the actuation is carried out using two separate paths, for example also with a respectively dedicated microcontroller. This permits reliable actuation (for example in terms of fail safety and/or incorrect actuation).

The drive control device is also advantageously configured to actuate the hydromechanical safety means directly. Since valves which can be actuated, for example electromagnetically, can be used as hydromechanical safety means, the actuation thereof does not require a high level of power, with the result that the actuation can be carried out directly using the drive control device, for example by means of an electronic module present therein.

Alternatively, the drive device is also configured to actuate at least one actuation control module which is in turn configured to actuate the hydromechanical safety means. It is possible thus, for example, to use an actuation module which is already present and which can already be reliably actuated by the drive control device. All that is then necessary is for the actuation of the safety means to be adapted by means of the actuation module. In the case of an actuation module, for example two structurally identical valves can be actuated together, and in the case of two actuation modules two different valves can be actuated. It is therefore possible, in the sense of diversification, to increase the fail safety of the two valves compared to two structurally identical valves.

State monitoring, in particular on two channels, is preferably provided for the state of the hydromechanical safety means. It is therefore possible to increase the safety of the electro-hydraulic drive further.

It is advantageous if the drive control device is also configured to detect and/or monitor operating variables of the electric motor and/or of the movable element. The drive control device is then expediently also configured to interrupt the operation of the electric motor as a function of the detected and/or monitored operating variables and/or to actuate the hydromechanical safety means in such a way that the flow of hydraulic fluid between the hydraulic pump and the hydraulic consumer is interrupted. An operating variable of the movable element can be, in particular, a position and/or a speed.

The detection of the operating variables of the electric motor permits the electric motor to be, for example, selectively actuated and monitored. The detection of the operating variables of the movable element ensures a further increase in the safety since, for example, it can be checked whether the desired actuation is active or not. If necessary, it is therefore possible, for example, to detect a further movement of the movable element, for example on the basis of leakage in the hydraulic fluid circuit, despite an interruption of the operation of the electric motor. The safety means can be actuated in response to this.

The detection and/or monitoring of the operating variables of the electric motor and of the movable element permits reliable monitoring of the movable element, in particular with respect to its speed, since monitoring of two different signals reduces the probability of failure. In this context, a speed of the movable element can be inferred for example on the basis of the flow of hydraulic fluid from the hydraulic consumer through the hydraulic, of the displacement volume of the hydraulic pump and rotational speed of the electric motor.

Furthermore, safety-relevant parameters such as, for example, door-locking signals, enabling signals, limitation of the rotational speed, limitation of the torque, limitation of the current or setpoint/actual value curves of a position control system can be monitored with the drive control device, in order, for example, to actuate the electric motor and, if appropriate, the safety means correspondingly.

An electro-hydraulic drive according to the invention has a drive control device according to the invention, an electric motor with a variable rotational speed, a hydraulic pump which is driven by the electric motor, a hydraulic consumer with a movable element and hydromechanical safety means which are configured to be able to interrupt a flow of hydraulic fluid between the hydraulic pump and the hydraulic consumer.

In particular, the hydromechanical safety means comprise two valves which are structurally identical or different. The valves may be, for example, shutoff valves or lifting valves. The electro-hydraulic drive may be, in particular, an electro-hydraulic axle which is used, for example, for what is referred to as a deep-drawing press, an injection molding machine or else also in some other shaping technology machine.

With respect to the advantages of an electro-hydraulic drive according to the invention, reference is made at this point to the avoidance of repetitions of the above statements with respect to the drive control device according to the invention.

The method according to the invention serves to stop the movable element of an electro-hydraulic drive according to the invention. Here, as a function of a speed of the movable element, the operation of the electric motor is interrupted by means of the drive control device and/or the flow of hydraulic fluid between the hydraulic pump and the hydraulic consumer is interrupted with the hydromechanical safety means, wherein the hydromechanical safety means are actuated for this purpose by means of the drive control device.

Depending on the necessary or desired method of stopping, either only the operation of the electric motor can be interrupted or only the flow of hydraulic fluid between the hydraulic pump and the hydraulic consumer can be interrupted. If one of the two methods is not sufficient to stop the movable element, both methods can be used.

The speed of the movable element is preferably detected and/or monitored by means of operating variables of the electric motor and/or of the movable element. By means of the detection of the operating variables of the electric motor it is possible for the electric motor to be selectively actuated and monitored, for example. The detection of the operating variables of the movable element ensures a further increase in safety, since, for example, it can be checked whether the desired actuation is effective or not.

Detection and/or monitoring of the operating variables of the electric motor and of the movable element permit reliable monitoring of the speed of the movable element, since the probability of failure is reduced by monitoring two different signals.

The operation of the electric motor is advantageously firstly interrupted and then, if the movable element continues to have an excessively high speed, the flow of hydraulic fluid between the hydraulic pump and the hydraulic consumer is interrupted with the hydromechanical safety means. In this way, a plurality of steps can be made available which, depending on the case, do not all have to be run through if appropriate. For example, the safety means have to be actuated only when absolutely necessary for safety reasons because, for example, stopping the movable element solely by means of interruption of the operation of the electric motor is not sufficient.

It is advantageous if the speed of the movable element is adjusted to zero before the interruption of the operation of the electric motor. It is thus possible to attempt, even before the switching off of any components, to bring about stopping by means of a control process. Only if this is not possible, can the process then be continued with the steps already mentioned. It is therefore possible to run through finely graduated safety steps when the movable element is stopped, wherein, depending on the situation, if appropriate not all the steps have to be run through. It is therefore possible to ensure stopping in a way which reduces wear on components.

A drive control device according to the invention, a hydraulic drive according to the invention and/or a method according to the invention are preferably used in deep drawing (both in deep drawing and in upper tools), bending machines, bale presses, scrap presses, forging presses, fine-cutting presses, composite fiber presses, roller mills, smelting works, injection molding machines, blow-molding machines, pressure casting machines, processing centers, testing machines, simulators, shaft compensators, servo presses, pipe and wire bending machines, trimming machines, punching and nibbling machines, automatic punching and shaping machines, suction transfer and compact suction presses, tire presses, tire body machines, vulcanizing presses, transfer and multiple-stage presses, extrusion presses, bending centers, powder metal presses.

Further advantages and refinements of the invention can be found in the description and the appended drawing.

Of course, the features which are mentioned above and features which are still to be explained below can be used not only in the respectively specified combination but also in other combinations or alone without departing from the scope of the present invention.

The invention is illustrated schematically on the basis of exemplary embodiments in the drawing and will be described below with reference to the drawing.

### DESCRIPTION OF THE FIGURES

FIG. 1 is a schematic view of an electro-hydraulic drive according to the invention in a preferred refinement,

FIG. 2 is a schematic view of an electro-hydraulic drive according to the invention in a further preferred refinement,

FIG. 3 is a schematic view of an electro-hydraulic drive according to the invention in a further preferred refinement,

FIG. 4 is a schematic view of a circuit for actuating the safety means in an electro-hydraulic drive in a preferred refinement, and

FIGS. 5a and 5b are schematic views of a circuit for actuating the safety means in an electro-hydraulic drive in further preferred refinements.

### DETAILED DESCRIPTION OF THE DRAWING

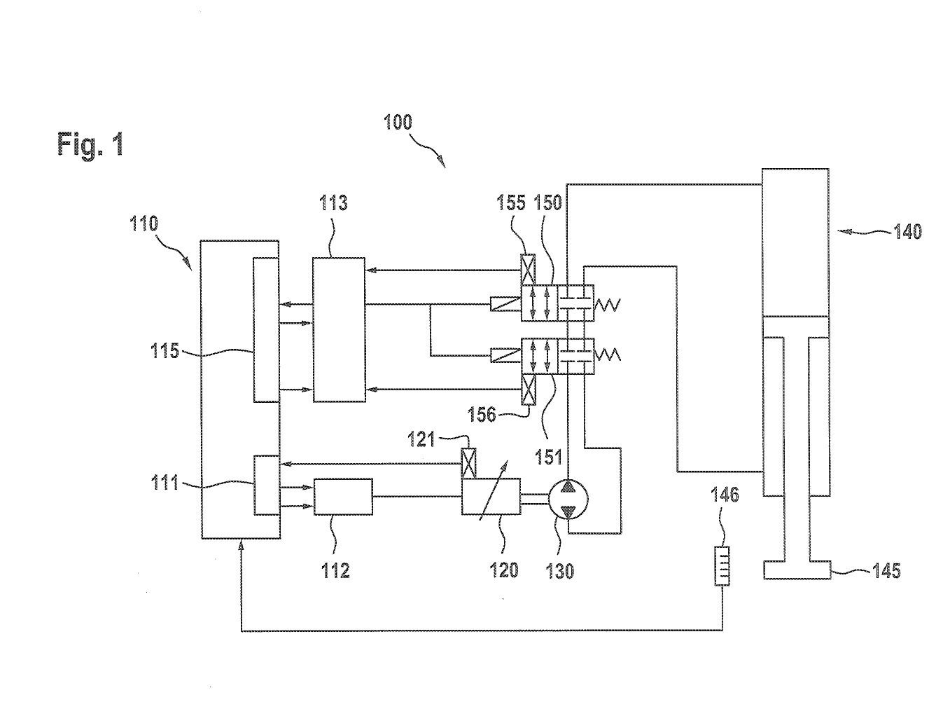

FIG. 1 is a simplified and schematic view of a preferred embodiment of an electro-hydraulic drive 100 according to the invention which is embodied as an electro-hydraulic axle. The electro-hydraulic drive 100 has a drive control device 110 according to the invention, also in a preferred refinement, an electric motor 120 with a variable rotational speed, a hydraulic pump 130 which is coupled to the electric motor 120, for example an axial piston pump which is embodied as a constant-displacement pump, and a hydraulic consumer 140. The hydraulic consumer 140 is embodied here as a cylinder with a movable element 145, for example a piston with a piston rod.

Furthermore, hydromechanical safety means which are embodied as two valves 150, 151 are provided. The two valves 150, 151 are arranged in the hydraulic circuit between the hydraulic pump 130 and the hydraulic consumer 140, with the result that each of the two valves can interrupt the flow of hydraulic fluid between the hydraulic pump 130 and the hydraulic consumer 140 on both sides of the hydraulic pump 130.

The use of the two valves serves to increase the protection against possible failure of one of the valves. It is therefore possible for the flow of hydraulic fluid still to be interrupted even when one of the valves fails. The two valves 150, 151 are of the same design here, and as a result both can be actuated together. Furthermore, the two valves 150, 151 can be actuated in an electromagnetic fashion.

The drive control device 110 serves to actuate and to operate the electric motor 120. For this purpose, a control component 111 is provided on which actuation commands for a power component 112, for example a frequency inverter, for operating the electric motor 120 are generated. For example, the power component 112 can be disabled by means of the control component 111 if it is necessary to interrupt the operation of the electric motor 120. Likewise, the power component 112 can be enabled by means of the control component 111 if operation of the electric motor 120 is required.

Furthermore, the drive control device 110 can pick up operating variables of the electric motor 120 which are detected by a signal generator 121, by means of the control component 111 here. This permits selective control of the electric motor 120, for example with respect to its rotational speed and/or its torque. The power component 112 can be arranged, for example, on the electric motor 120 and correspondingly connected to the control component 111 in the drive control device 110, but it is also conceivable to arrange the power component 112 as a module in a housing of the drive control device 110. The power component 112 therefore does not necessarily have to be part of the drive control device 110, since the actuation for operation and interruption of the operation take place by means of the control component 111, while the power component 112 merely outputs the predefined variables, such as, for example, current or frequency for the operation of the electric motor 120.

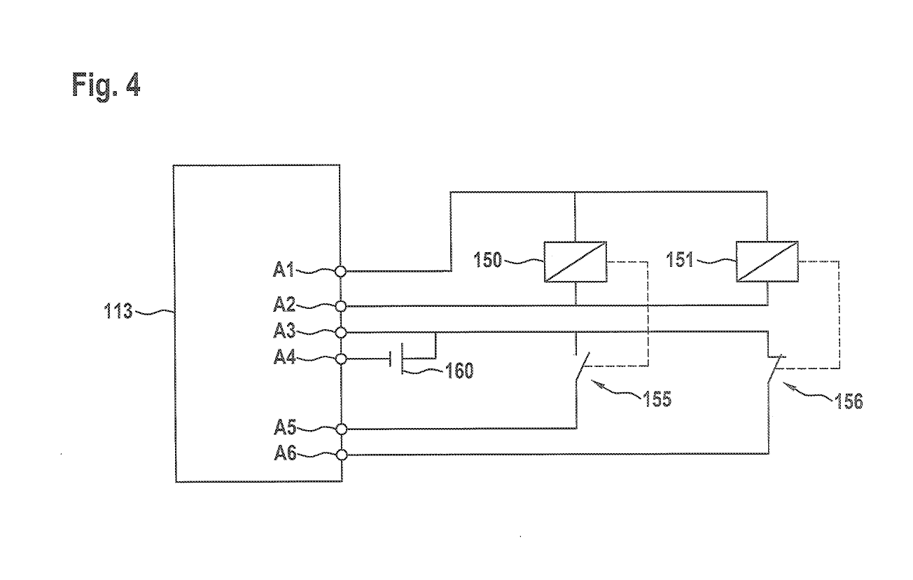

Furthermore, the drive control device 110 serves to actuate the two valves 150, 151. For this purpose, an actuation module 113 is actuated on two channels by a control component 115 and in turn actuates the two valves 150, 151 together. Two-channel actuation means that the actuation module 113 is actuated on two separate paths, for example also with two different microcontrollers. Therefore, reliable actuation (for example in terms of fail safety and/or incorrect actuation) is achieved. A signal generator 155 or 156 with which a setting of the respective valve, that is to say its state, can be monitored, is arranged on each of the valves 150, 151. The signals which are output by the signal generators 155, 156 can for this purpose be picked up by the actuation module 113 and transmitted to the control component 115. Here, a feedback contact, on the one hand a normally closed contact and on the other a normally open contact, is provided for each valve here. For a more detailed illustration of the circuit of the valves 150, 151 and of the actuation module 113, reference is made at this point to FIG. 4.

The current position of the movable element 145 in terms of an operating variable can be detected with a signal generator 146, for example travel sensor, and transmitted to the drive control device 110. Likewise, for example the speed of the movable element 145 can be detected and transmitted. For example control of the position or speed of the movable element 145 can be made possible or improved with these operating variables of the movable element 145.

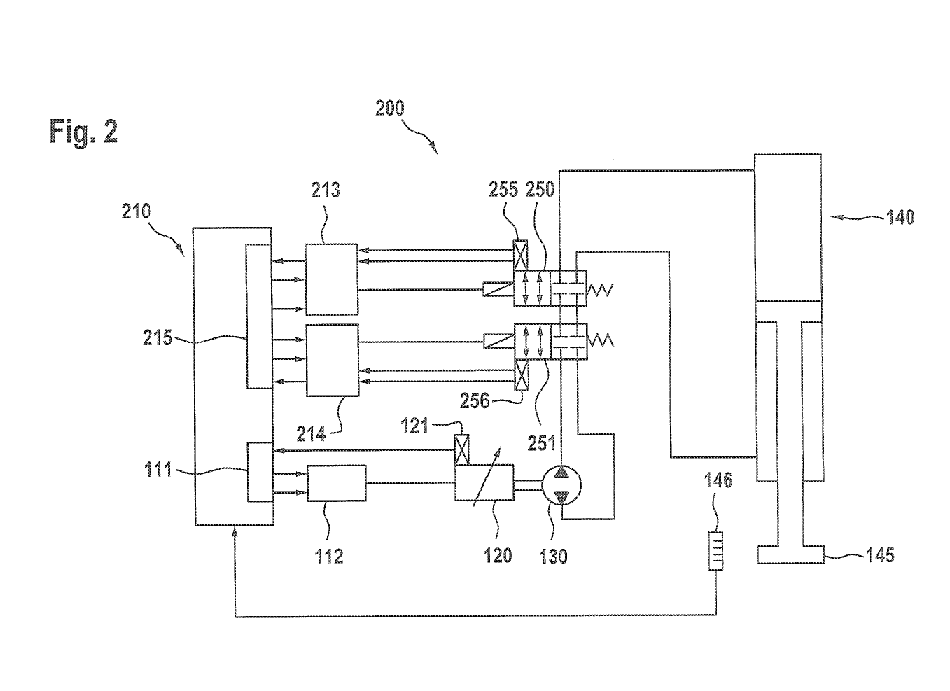

FIG. 2 shows a simplified and schematic view of a further preferred embodiment of an electro-hydraulic drive 200 according to the invention which is embodied as an electro-hydraulic axle. The electro-hydraulic drive 200 has a drive control device 210 according to the invention, also in a further preferred embodiment, an electric motor 120 with a variable rotational speed, a hydraulic pump 130 which is coupled to the electric motor 120, and a hydraulic consumer 140.

The electro-hydraulic drive 200 shown here corresponds in terms of the electric motor 120, the actuation thereof by means of the drive control device with the control component 111 and power component 112, the hydraulic pump 130, the hydraulic consumer 140 and the signal generators 121 and 146 with the electro-hydraulic drive 100 shown in FIG. 1. In this respect, reference is made to the statements there.

Furthermore, hydromechanical safety means which are embodied as two valves 250, 251 are provided. The two valves 250, 251 are arranged in the hydraulic circuit between the hydraulic pump 130 and the hydraulic consumer 140, with the result that each of the two valves can interrupt the flow of hydraulic fluid between the hydraulic pump 130 and the hydraulic consumer 140 on both sides of the hydraulic pump 130.

In contrast to the embodiment in FIG. 1, the two valves 250, 251 are valves of a different design, in particular different valves which are usually used as standard valves. This serves to increase the protection against possible failure of one of the valves, since owing to the different valves, for example, different influences can lead to a failure. Furthermore, the two valves 250, 251 can be actuated electromagnetically.

The drive control device 210 serves to actuate and to operate the electric motor 120. The actuation takes place precisely as explained with respect to FIG. 1. Furthermore, the drive control device 210 serves to actuate the two valves 250, 251 which are actuated separately here, that is to say by means of two actuation paths which are separate from one another. For this purpose, firstly an actuation module 213 and an actuation module 214 are each actuated on two channels by a control component 215, after which the valve 250 is actuated by an actuation module 213, and the valve 251 by the actuation module 214. Each of the actuation modules 213 and 214 can be, for example, an actuation module like the actuation module 113 as shown in FIG. 1 wherein, if appropriate, corresponding adaptation of the circuit and of the actuation is necessary.

A signal generator 255 or 256 with which a position of the respective valve, that is to say the state thereof, can be monitored, is arranged on each of the valves 250, 251. The signals which are output by the signal generator 255 can for this purpose be picked up by the actuation module 213, and the signals which are output by the signal generator 256 can be picked up by the actuation module 214, and the signals can be respectively transmitted to the control component 215. Two feedback contacts, in each case a normally closed contact and a normally open contact, are provided for each valve here. This permits a high level of reliability in terms of the monitoring of the state of the valves.

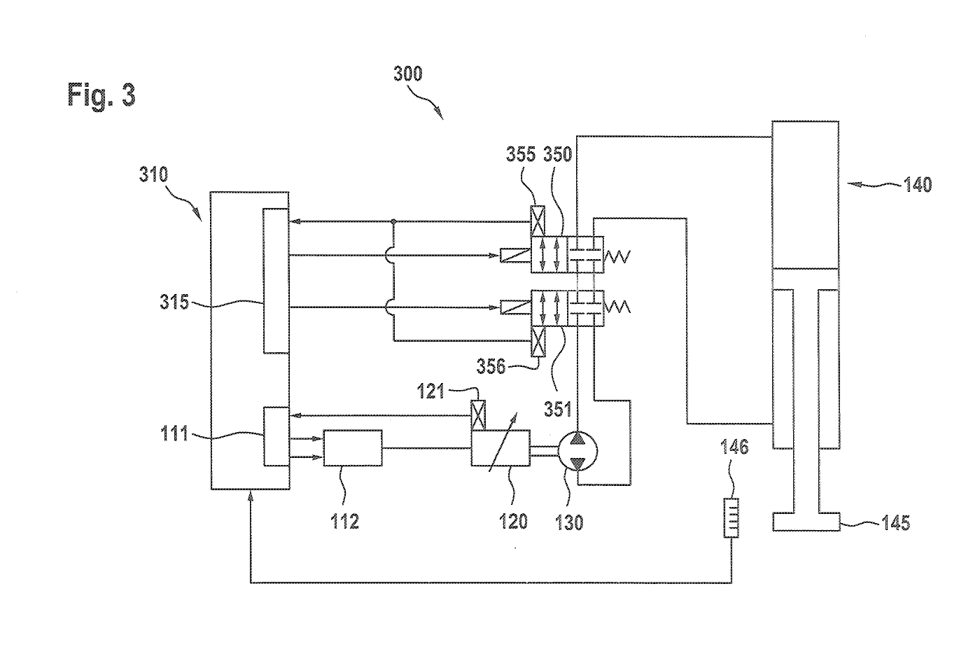

FIG. 3 shows a simplified and schematic view of the further preferred embodiment of an electro-hydraulic drive 300 according to the invention which is embodied as an electro-hydraulic axle. The electro-hydraulic drive 300 has a drive control device 310 according to the invention, also in a further preferred embodiment, an electric motor 120 with a variable rotational speed, a hydraulic pump 130 which is coupled to the electric motor 120, and a hydraulic consumer 140.

The electro-hydraulic drive 300 which is shown here corresponds in terms of the electric motor 120, the actuation thereof by means of the drive control device with the control component 111 and the power component 112, the hydraulic pump 130 of the hydraulic consumer 140, the signal generator 121 and the signal generator 146 to the electro-hydraulic valve 100 which is shown in FIG. 1. In this respect, reference is made at this point to the statements there.

Furthermore, hydromechanical safety means which are embodied as two valves 350, 351 are provided. The two valves 350, 351 are arranged in the hydraulic circuit between the hydraulic pump 130 and the hydraulic consumer 140, with the result that each of the two valves can interrupt the flow of hydraulic fluid between the hydraulic pump 130 and the hydraulic consumer 140 on both sides of the hydraulic pump 130. The two valves can be structurally identical valves such as, for example, the valves which are shown in FIG. 1.

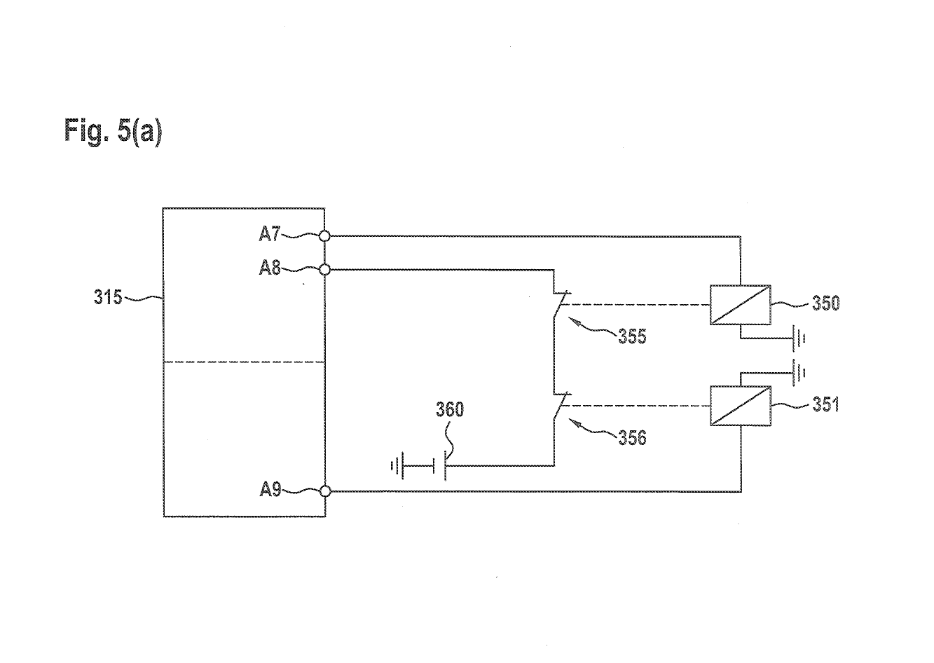

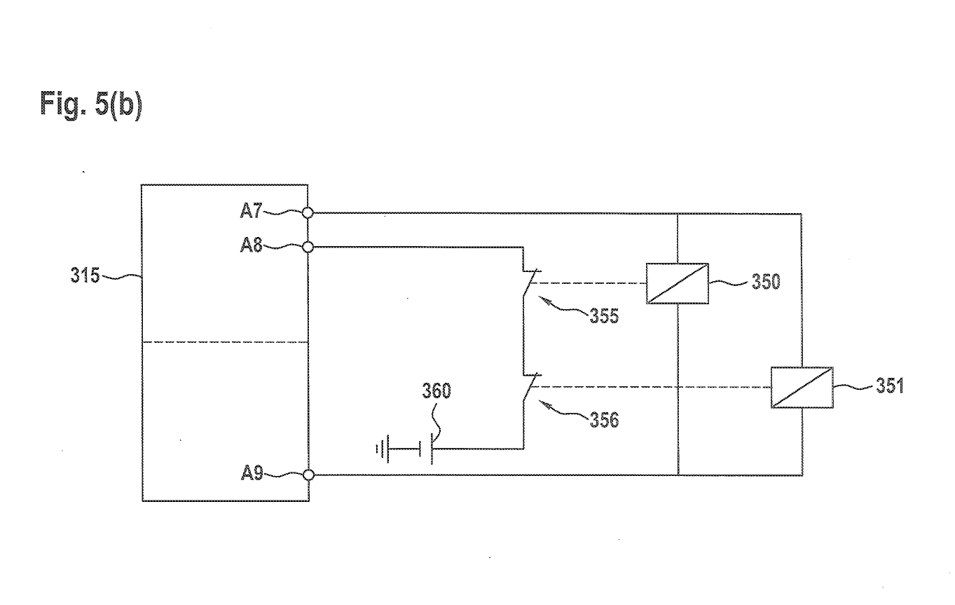

The drive control device 310 serves to actuate and operate the electric motor 120. The actuation takes places precisely as explained with respect to FIG. 1. Furthermore, the drive control device 310 serves to actuate the two valves 350, 351. Arranged on each of the valves 350, 351 is a signal generator 255 or 256 with which a position of the respective valve, that is to say the state thereof, can be monitored. The signals which are output by the signal generators 255, 256 can be picked up by the control component 315 for this purpose. For a more detailed illustration of the circuit of the valves 350, 351 and of the control component 315, reference is made at this point to FIGS. 5a and 5b.

FIG. 4 is a schematic view of a circuit for actuating the safety means in the electro-hydraulic drive 100, as is illustrated in FIG. 1. The two valves 150, 151 are connected for the purpose of actuation to the actuation module 113 via the connections A1 and A2. The two valves are connected in parallel here.

A signal generator 155 with a feedback contact which is embodied as a normally open contact is assigned to the valve 150, and a signal generator 156 with a feedback contact which is embodied as a normally closed contact is assigned to the valve 151. The feedback contacts of the signal generators 155, 156 are connected to a common voltage supply 160, for example 24 V, via the connections A3 and A4 on the actuation module 113.

Furthermore, the feedback contact of the signal generator 155 is connected to a connection A5 which is embodied as a signal input, and a feedback contact on the signal generator 156 is connected to a connection A6, embodied as a signal input, of the actuation module 113. The actuation module 113 and therefore the actuation control device 110 therefore receive two different signals relating to the state of the commonly actuated valves 150, 151.

FIG. 5a shows a schematic view of a possible circuit for actuating the safety means in the electro-hydraulic drive 300 as is illustrated in FIG. 3. The valve 350 is connected for the purpose of actuation to the control component 315 via the connection A7, and the valve 351 is connected for the purpose for actuation to the control component 315 via the connection A9. Furthermore, the two valves 350, 351 are connected to ground. The two connections A7 and A9 constitute here two different channels, for example each dedicated microcontroller. Therefore, each of the two valves can be actuated over the two channels, in that the respective connection A7 or A9 is connected positively.

A signal generator 355 with a feedback contact which is embodied as a normally closed contact is assigned to the valve 350, and a signal generator 356 with a feedback contact which is embodied as a normally closed contact is assigned to the valve 351. The feedback contacts of the signal generators 155, 156 are connected to a common supply voltage 360, for example 24 V, and to the control component 315 via the connection A8. In this way, the control component 315, and therefore the actuation control device 310, receive a common signal relating to the state of the separately actuated valves 350, 351.

A further possible circuit for actuating the safety means in the electro-hydraulic drive 300 as illustrated in FIG. 3 is shown schematically in FIG. 5b. The valve 350 and the valve 351 are connected for the purpose of actuation to the control component 315 via the connection A7. Furthermore, the two valves 35, 351 are connected to the connection A9. The two connections A7 and A9 constitute here two different channels, for example each dedicated microcontroller. The two valves can therefore be actuated jointly via the two channels, in that, for example, the connection A7 is connected positively and the connection A9 is connected negatively.

A signal generator 355 with a feedback contact which is embodied as a normally closed contact is assigned to the valve 350, and a signal generator 356 with a feedback contact which is embodied as a normally closed contact is assigned to the valve 351. The feedback contacts of the signal generators 155, 156 are connected to a common voltage supply 360, for example 24 V, and to the control component 315 via the connection A8. The control component 315, and therefore the actuation control device 310, thus receive a common signal about the state of the separately actuated valves 350, 351.

1. A drive control device for operating an electro-hydraulic drive which has an electric motor with a variable rotational speed, a hydraulic pump which is driven by the electric motor, a hydraulic consumer with a movable element, and hydromechanical safety device which is configured to be able to interrupt a flow of hydraulic fluid between the hydraulic pump and the hydraulic consumer, comprising:
a controller configured to actuate the electric motor for operation, and to interrupt the operation of the electric motor, and
wherein the drive control device is configured to actuate the hydromechanical safety device in such a way that the flow of hydraulic fluid between the hydraulic pump and the hydraulic consumer is interrupted.

2. The drive control device according to claim 1, wherein the drive control device is also configured to actuate at least one of the electric motor and the hydromechanical safety device on two channels.

3. The drive control device according to claim 1, wherein the drive control device is also configured to actuate the hydromechanical safety device directly.

4. The drive control device according to claim 1, wherein the drive control device is also configured to actuate at least one actuation module which is in turn configured to actuate the hydromechanical safety device.

5. The drive control device according to claim 1, further comprising:
a state monitoring system configured to monitor a state of the hydromechanical safety device.

6. The drive control device according to claim 1, the drive control device is also configured to at least one of detect and monitor operating variables of at least one of the electric motor and of the movable element.

7. The drive control device according to claim 6, wherein the drive control device is also configured to interrupt the operation of the electric motor as a function of the detected and/or monitored operating variables and/or to actuate the hydromechanical safety device in such a way that the flow of hydraulic fluid between the hydraulic pump and the hydraulic consumer is interrupted.

8. An electro-hydraulic drive comprising:
an electric motor with a variable rotational speed;
a hydraulic pump which is driven by the electric motor;
a hydraulic consumer with a movable element;
hydromechanical safety device which is configured to be able to interrupt a flow of hydraulic fluid between the hydraulic pump and the hydraulic consumer; and
a drive control device configured (i) to actuate the electric motor for operation, and to interrupt the operation of the electric motor, and (ii) to actuate the hydromechanical safety device in such a way that the flow of hydraulic fluid between the hydraulic pump and the hydraulic consumer is interrupted.

9. The electro-hydraulic drive according to claim 8, wherein the hydromechanical safety device comprises two valves which are structurally identical or different.

10. A method for stopping a movable element of an electro-hydraulic drive having a drive control device including an electric motor with a variable rotational speed, a hydraulic pump which is driven by the electric motor, a hydraulic consumer with a movable element, and hydromechanical safety device which is configured to be able to interrupt a flow of hydraulic fluid between the hydraulic pump and the hydraulic consumer, wherein, as a function of a speed of the movable element, the method comprises:
adjusting the speed of the movable element to zero;
interrupting the operation of the electric motor with the drive control device; and
interrupting the flow of hydraulic fluid between the hydraulic pump and the hydraulic consumer with the hydromechanical safety device, the hydromechanical safety device actuated for this purpose with the drive control device.

11. The method according to claim 10, wherein further comprising:
detecting or monitoring the speed of the movable element with operating variables of the electric motor and/or of the movable element.

12. The method according to claim 10, further comprising:
in a first step adjusting the speed of the movable element to zero;
in a second step interrupting the operation of the electric motor; and
in a third step interrupting the flow of hydraulic fluid between the hydraulic pump and the hydraulic consumer with the hydromechanical safety device.

13. The method according to claim 12, further comprising:
passing through the second and third steps only if the movable element has not yet been stopped in a preceding step.

14. The method according to claim 12, further comprising:
monitoring each step on two channels.

15. The drive control device according to claim 5, wherein the state monitoring system is configured to monitor the state of the hydromechanical safety device on two channels.
